(19) United States
(12) Patent Application Publication
(10) Pub. No.: US 2010/0221525 A1
(43) Pub. Date: Sep. 2, 2010

(54) NANOPARTICLES

(76) Inventors: Gerhard Jonschker, Spiessen-Elversberg (DE); Matthias Koch, Wiesbaden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/063,824

(22) PCT Filed: Oct. 26, 2006
(86) PCT No.: PCT/EP06/10330

§ 371 Date: Feb. 14, 2008

(30) Foreign Application Priority Data
Nov. 25, 2005 (DE) 10 2005 056 621.9

(51) Int. Cl. B32B 5/16; D02G 3/02; C08K 9/04

(52) U.S. Cl. 428/327; 428/372; 523/205; 977/773

(57) ABSTRACT

The invention relates to zinc oxide nanoparticles having an average particle size, determined by particle correlation spectroscopy (PCS), in the range from 3 to 20 nm whose particle surface has been modified by means of at least one copolymer comprising at least one monomer containing hydrophobic radicals and at least one monomer containing hydrophilic radicals, dispersed in an organic solvent, characterised in that they are obtainable by a process in which in a step a) one or more precursors of the nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the absorption edge in the UV/VIS spectrum of the reaction solution has reached the desired value, and optionally in step c) the alcohol from step a) is removed and replaced by another organic solvent, to isolated particles, and to the use thereof for UV protection in polymers.

The invention relates to modified zinc oxide nanoparticles, to a process for the production of such particles, and to the use thereof for UV protection.

The incorporation of inorganic nanoparticles into a polymer matrix can influence not only the mechanical properties, such as, for example, impact strength, of the matrix, but also modifies its optical properties, such as, for example, wavelength-dependent transmission, colour (absorption spectrum) and refractive index. In mixtures for optical applications, the particle size plays an important role since the addition of a substance having a refractive index which differs from the refractive index of the matrix inevitably results in light scattering and ultimately in light opacity. The drop in the intensity of radiation of a defined wavelength on passing through a mixture shows a high dependence on the diameter of the inorganic particles.

In addition, a very large number of polymers are sensitive to UV radiation, meaning that the polymers have to be UV-stabilised for practical use. Many organic UV filters which would in principle be suitable here as stabilisers are unfortunately themselves not photostable, and consequently there continues to be a demand for suitable materials for long-term applications.

Suitable substances consequently have to absorb in the UV region, appear as transparent as possible in the visible region and be straight-forward to incorporate into polymers. Although numerous metal oxides absorb UV light, they can, however, for the above-mentioned reasons only be incorporated with difficulty into polymers without impairing the mechanical or optical properties in the region of visible light.

The development of suitable nanomaterials for dispersion in polymers requires not only control of the particle size, but also of the surface properties of the particles. Simple mixing (for example by extrusion) of hydrophilic particles with a hydrophobic polymer matrix results in inhomogeneous distribution of the particles throughout the polymer and additionally in aggregation thereof. For homogeneous incorporation of inorganic particles into polymers, their surface must therefore be at least hydrophobically modified. In addition, the nanoparticulate materials, in particular, exhibit a great tendency to form agglomerates, which also survive subsequent surface treatment.

The literature contains various approaches to providing suitable particles:

International Patent Application WO 2005/070820 describes polymer-modified nanoparticles which are suitable as UV stabilisers in polymers. These particles can be obtained by a process in which in a step a) an inverse emulsion comprising one or more water-soluble precursors of the nanoparticles or a melt is prepared with the aid of a random copolymer comprising at least one monomer containing hydrophobic radicals and at least one monomer containing hydrophilic radicals, and in a step b) particles are produced. These particles are preferably ZnO particles having a particle size of 30 to 50 nm with a coating of a copolymer essentially consisting of lauryl methacrylate (LMA) and hydroxyethyl methacrylate (HEMA). The ZnO particles are produced, for example, by basic precipitation from an aqueous zinc acetate solution.

International Patent Application WO 2000/050503 describes a process for the preparation of zinc oxide gels by basic hydrolysis of at least one zinc compound in alcohol or an alcohol/water mixture, which is characterised in that the precipitate initially forming during the hydrolysis is allowed to mature until the zinc oxide has completely flocculated out, this precipitate is then compacted to give a gel and separated off from the supernatant phase.

International Patent Application WO 2005/037925 describes the production of ZnO and ZnS nanoparticles which are suitable for the preparation of luminescent plastics. The ZnO particles are precipitated from an ethanolic solution of zinc acetate by means of ethanolic NaOH solution and allowed to age for 24 hours before the ethanol is replaced by butanediol monoacrylate.

International Patent Application WO 2004/106237 describes a process for the production of zinc oxide particles in which a methanolic potassium hydroxide solution having a hydroxide ion concentration of 1 to 10 mol of OH per kg of solution is added to a methanolic solution of zinc carboxylic acid salts having a zinc ion concentration of 0.01 to 5 mol of Zn per kg of solution in a molar OH:Zn ratio of 1.5 to 1.8 with stirring, and the precipitation solution obtained when the addition is complete is matured at a temperature of 40 to 65° C. over a period of 5 to 50 min and finally cooled to a temperature of ≦25° C., giving particles which are virtually spherical.

The dissertation by K. Feddern (“Synthese and optische Eigenschaften von ZnO Nanokristallen” [Synthesis and Optical Properties of ZnO Nanocrystals], University of Hamburg, June 2002) describes the production of ZnO particles from zinc acetate by means of LiOH in isopropanol. The particles can be coated with SiO₂ here by the so-called “Stöber process” by reaction with tetraethoxysilane in the presence of ammonia, but cloudy dispersions form here. The coating of dispersed ZnO particles with orthophosphate or tributyl phosphate or diisooctyl-phosphinic acid is also described here.

In all these processes, however, precise setting of the absorption and scattering behaviour and control of the particle size are difficult or only possible to a limited extent.

It would therefore be desirable to have a process by means of which small zinc oxide nanoparticles can be formed directly by means of a suitable surface modification, wherever possible in an agglomerate-free manner, where the resultant particles in dispersions absorb radiation in the UV region, but hardly absorb or scatter any radiation in the visible region.

Surprisingly, it has now been found that this is possible if the particle formation is monitored and terminated at the desired time by addition of a modifier.

The present invention therefore relates firstly to zinc oxide nanoparticles having an average particle size, determined by particle correlation spectroscopy (PCS), in the range from 3 to 20 nm whose particle surface has been modified by means of at least one copolymer comprising at least one monomer containing hydrophobic radicals and at least one monomer containing hydrophilic radicals, dispersed in an organic solvent, characterised in that they are obtainable by a process in which in a step a) one or more precursors of the nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the absorption edge in the UV/VIS spectrum of the reaction solution has reached the desired value, and optionally in step c) the alcohol from step a) is removed and replaced by another organic solvent.

The ZnO nanoparticles according to the invention which are present, dispersed by the process described, can also be isolated. This is achieved by removing the alcohol from step a) to dryness.

The present invention furthermore relates to a corresponding process for the production of zinc oxide nanoparticles having an average particle size, determined by particle correlation spectroscopy (PCS), in the range from 3 to 20 nm whose particle surface has been modified by means of at least one copolymer comprising at least one monomer containing hydrophobic radicals and at least one monomer containing hydrophilic radicals, dispersed in an organic solvent, characterised in that in a step a) one or more precursors of the nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the absorption edge in the UV/VIS spectrum of the reaction solution has reached the desired value, and optionally in step c) the alcohol from step a) is removed and replaced by another organic solvent.

Depending on the precursor employed, as described below, the salt forming during the ZnO formation is filtered off in step c). The alcohol from step a) is distilled off to dryness, the residue is taken up in another organic solvent in which the salt load does not dissolve, the salt load is filtered, and the organic solvent is again distilled off to dryness.

The particles according to the invention are distinguished by high absorption in the UV region, particularly preferably in the UV-A region, together with high transparency in the visible region. In contrast to many zinc oxide grades known from the prior art, these properties of the particles according to the invention do not change on storage or only do so to a negligible extent.

The particle size is determined, in particular, by particle correlation spectroscopy (PCS), where the investigation is carried out using a Malvern Zetasizer in accordance with the operating manual. The diameter of the particles is determined here as the d50 or d90 value.

At the same time, the use of the copolymers enables the nanoparticles to be isolated from the dispersions in a virtually agglomerate-free manner, since the individual particles are coated with the polymer immediately after their formation.

In addition, the nanoparticles obtainable using this method can be redispersed particularly easily and uniformly, where, in particular, undesired impairment of the transparency of such dispersions in visible light can be substantially avoided.

In preferred embodiments, the process according to the invention furthermore allows simple removal of by-products, making complex purification of the products superfluous.

Copolymers preferably to be employed in accordance with the invention exhibit a weight ratio of structural units containing hydrophobic radicals to structural units containing hydrophilic radicals in the random copolymers which is in the range 1:2 to 500:1, preferably in the range 1:1 to 100:1 and particularly preferably in the range 7:3 to 10:1. The weight average molecular weight of the random copolymers is usually in the range from M_{w}=1000 to 1,000,000 g/mol, preferably in the range from 1500 to 100,000 g/mol and particularly preferably in the range 2000 to 40,000 g/mol.

The weight average molecular weight of the random copolymers is determined by GPC (GPC=gel permeation chromatography) against PMMA standard (PMMA=polymethyl methacrylate).

It has been found here that, in particular, copolymers which conform to the formula I

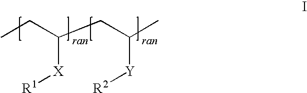

where X and Y correspond to the radicals of conventional nonionic or ionic monomers, and
R¹ stands for hydrogen or a hydrophobic side group, preferably selected from branched or unbranched alkyl radicals having at least 4 carbon atoms, in which one or more, preferably all, H atoms may be replaced by fluorine atoms, and
R² stands for a hydrophilic side group, which preferably contains one or more phosphonate, phosphate, phosphonium, sulfonate, sulfonium, (quaternary) amine, polyol or polyether radicals, particularly preferably one or more hydroxyl radicals,
ran means that the respective groups are arranged in a random distribution in the polymer, and where —X—R¹ and —Y—R² within a molecule may each have a plurality of different meanings, and the copolymers, besides the structural units shown in formula I, may contain further structural units, preferably those without or with short side chains, such as, for example, C₁₋₄-alkyl, meet the requirements according to the invention in a particular manner.

Particular preference may be given in accordance with the invention to the use of random copolymers. Polymers of this type and the preparation thereof are described in International Patent Application WO 2005/070979, the disclosure content of which in this respect expressly also belongs to the content of the present application.

In a variant of the invention, particular preference is given to polymers in which —Y—R² stands for a betaine structure.

Particular preference is in turn given here to polymers of the formula I in which X and Y, independently of one another, stand for —O—, —C(═O)—O—, —C(═O)—NH—, —(CH₂)ₙ—, phenylene or pyridyl. Furthermore, polymers in which at least one structural unit contains at least one quaternary nitrogen or phosphorus atom, where R² preferably stands for a —(CH₂)ₘ—(N⁺(CH₃)₂)—(CH₂)ₙ—SO₃⁻ side group or a —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ side group or a —(CH₂)ₘ—(P⁺(CH₃)₂)—(CH₂)ₙ—SO₃⁻ side group, where m stands for an integer from the range 1 to 30, preferably from the range 1 to 6, particularly preferably 2, and n stands for an integer from the range 1 to 30, preferably from the range 1 to 8, particularly preferably 3, can advantageously be employed.

It may be particularly preferred here for at least one structural unit of the copolymer to contain a phosphonium or sulfonium radical.

Random copolymers particularly preferably to be employed can be prepared in accordance with the following scheme:

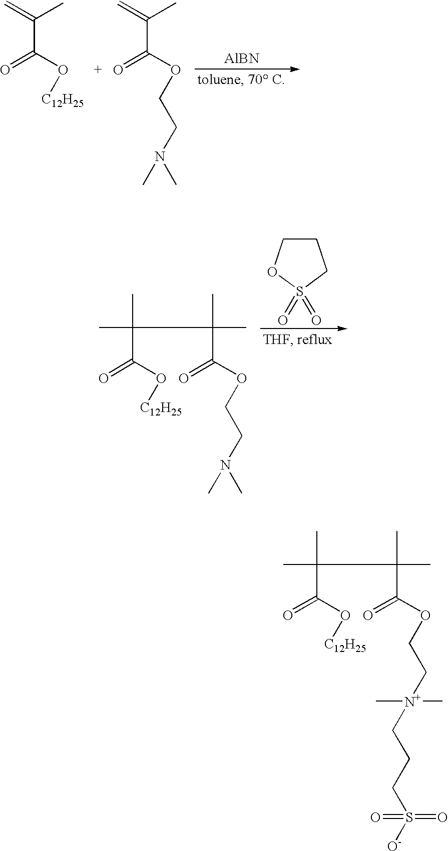

Here, the desired amounts of lauryl methacrylate (LMA) and dimethylaminoethyl methacrylate (DMAEMA) are copolymerised by known methods, preferably by means of free radicals in toluene by addition of AIBN. A betaine structure is subsequently obtained by reaction of the amine with 1,3-propane sultone by known methods.

In another variant of the invention, it is preferred to employ a copolymer essentially consisting of lauryl methacrylate (LMA) and hydroxyethyl methacrylate (HEMA), which can be prepared in a known manner by free-radical polymerisation using AIBN in toluene.

Alternative copolymers preferably to be employed may contain styrene, vinylpyrrolidone, vinylpyridine, halogenated styrene or methoxystyrene, where these examples do not represent a restriction. In another, like-wise preferred embodiment of the present invention, use is made of polymers which are characterised in that at least one structural unit is an oligomer or polymer, preferably a macromonomer, where polyethers, polyolefins and polyacrylates are particularly preferred as macromonomers.

Furthermore, besides the at least one structural unit containing hydrophobic radicals and the at least one structural unit containing hydrophilic radicals, the copolymers may contain further structural units, preferably those without hydrophilic or hydrophobic side chains or with short side chains, such as C₁₋₄-alkyl.

The modifier is added in the process according to the invention, as described above, depending on the desired absorption edge, but generally 1 to 20 hours after commencement of the reaction, preferably 4 to 15 hours after commencement of the reaction and particularly preferably after 5 to 10 hours.

The position of the absorption edge in the UV spectrum is dependent on the particle size in the initial phase of the zinc oxide particle growth. At the beginning of the reaction, it is at about 300 nm and shifts in the direction of 370 nm in the course of time. Addition of the modifier enables the growth to be interrupted at any desired point. A shift as close as possible to the visible region (from 400 nm) is desirable in order to achieve UV absorption over the broadest possible range. If the particles are allowed to grow too much, the solution becomes cloudy. The desired absorption edge is therefore in the range 300-400 nm, preferably in the range up to 320-380 nm. Optimum values have proven to be between 355 and 365 nm.

Precursors which can be employed for the nanoparticles are generally zinc salts. Preference is given to the use of zinc salts of carboxylic acids or halides, in particular zinc formate, zinc acetate or zinc propionate, as well as zinc chloride. The precursor used in accordance with the invention is very particularly preferably zinc acetate or the hydrate thereof.

The conversion of the precursors into zinc oxide is preferably carried out in accordance with the invention in basic medium, where, in a preferred process variant, a hydroxide base, such as LiOH, NaOH or KOH, is used.

The reaction, step a), in the process according to the invention is carried out in an alcohol. It has proven advantageous here for the alcohol to be selected so that the copolymer to be employed in accordance with the invention is soluble in the alcohol itself. In particular, methanol or ethanol is suitable. Ethanol has proven to be a particularly suitable solvent for step a) here.

Suitable organic solvents or solvent mixtures for the dispersion of the nanoparticles according to the invention, besides the alcohols in which they are initially obtained in the process, are typical surface-coating solvents. Typical surface-coating solvents are, for example, alcohols, such as methanol or ethanol, ethers, such as diethyl ether, tetrahydrofuran and/or dioxane, esters, such as butyl acetate, or hydrocarbons, such as toluene, petroleum ether, halogenated hydrocarbons, such as dichloromethane, or also commercially available products, such as solvent naphtha or products based on Shellsol, a high-boiling hydrocarbon solvent, for example Shellsol A, Shellsol T, Shellsol D40 or Shellsol D70.

The particles according to the invention preferably have an average particle size, determined by particle correlation spectroscopy (PCS) or transmission electron microscope, of 5 to 15 nm, in particular 7 to 12 nm and very particularly preferably about 10 nm. In specific, likewise preferred embodiments of the present invention, the distribution of the particle sizes is narrow, i.e. the d50 value, and in particularly preferred embodiments even the d90 value, is preferably in the above-mentioned ranges from 5 to 15 nm, or even from 7 to 12 nm.

In the sense of the use of these nanoparticles for UV protection in polymers, it is particularly preferred if the absorption edge of a dispersion lies with 0.001% by weight of the nanoparticles in the range 300-400 nm, preferably in the range up to 330-380 nm and particularly preferably in the range 355 to 365 nm. It is furthermore particularly preferred in accordance with the invention if the transmission of this dispersion (or also synonymously used suspension) with a layer thickness of 10 mm, comprising 0.001% by weight, where the % by weight data is limited by the investigation method, is less than 10%, preferably less than 5%, at 320 nm and greater than 90%, preferably greater than 95%, at 440 nm.

The measurement is carried out in a UV/VIS spectrometer (Varian Carry 50). The concentration of the solution here is matched to the instrument sensitivity (dilution to about 0.001% by weight).

The process according to the invention can be carried out as described above. The reaction temperature here can be selected in the range between room temperature and the boiling point of the solvent selected. The reaction rate can be controlled through a suitable choice of the reaction temperature, the starting materials and the concentration thereof and the solvent, so that the person skilled in the art is presented with absolutely no difficulties in controlling the rate in such a way that monitoring of the course of the reaction by UV spectroscopy is possible.

In certain cases, it may be helpful if an emulsifier, preferably a nonionic surfactant, is employed. Preferred emulsifiers are optionally ethoxylated or propoxylated, relatively long-chain alkanols or alkylphenols having various degrees of ethoxylation or propoxylation (for example adducts with 0 to 50 mol of alkylene oxide).

Dispersion aids can also advantageously be employed, preference being given to the use of water-soluble, high-molecular-weight organic compounds containing polar groups, such as polyvinylpyrrolidone, copolymers of vinyl propionate or acetate and vinylpyrrolidone, partially saponified copolymers of an acrylate and acrylonitrile, polyvinyl alcohols having various residual acetate contents, cellulose ethers, gelatine, block copolymers, modified starch, low-molecular-weight polymers containing carboxyl and/or sulfonyl groups, or mixtures of these substances.

Particularly preferred protective colloids are polyvinyl alcohols having a residual acetate content of less than 40 mol %, in particular 5 to 39 mol %, and/or vinylpyrrolidone-vinyl propionate copolymers having a vinyl ester content of less than 35% by weight, in particular 5 to 30% by weight.

Adjustment of the reaction conditions, such as temperature, pressure, reaction duration, enables the desired property combinations of the requisite nanoparticles to be set in a targeted manner. The corresponding adjustment of these parameters presents the person skilled in the art with absolutely no difficulties. For example, the reaction can for many purposes be carried out at atmospheric pressure and in the temperature range between 30 and 50° C.

The nanoparticles according to the invention, dispersed in an organic solvent or isolated, are used, in particular, for UV protection in polymers. In this application, the particles either protect the polymers themselves against degradation by UV radiation, or the polymer composition comprising the nanoparticles is in turn employed—for example in the form of a protective film or applied as a coating film—as UV protection for other materials. The present invention therefore furthermore relates to the corresponding use of nanoparticles according to the invention for the UV stabilisation of polymers and UV-stabilised polymer compositions essentially consisting of at least one polymer or a surface-coating composition, which is characterised in that the polymer comprises nanoparticles according to the invention. Polymers into which the isolated nanoparticles according to the invention can be incorporated well are, in particular, polycarbonate (PC), polyethylene terephthalate (PETP), polyimide (PI), polystyrene (PS), polymethyl methacrylate (PMMA) or copolymers comprising at least a proportion of one of the said polymers.

The incorporation can be carried out here by conventional methods for the preparation of polymer compositions. For example, the polymer material can be mixed with isolated nanoparticles according to the invention, preferably in an extruder or compounder.

A particular advantage of the particles according to the invention consists in that only a low energy input compared with the prior art is necessary for homogeneous distribution of the particles in the polymer.

The polymers here can also be dispersions of polymers, such as, for example, surface coatings. The incorporation can be carried out here by conventional mixing operations. The good redispersibility of the particles according to the invention will simplify in particular the preparation of dispersions of this type. Correspondingly, the present invention furthermore relates to dispersions of the particles according to the invention comprising at least one polymer.

The polymer compositions according to the invention comprising the isolated nanoparticles or the dispersions according to the invention are furthermore also suitable, in particular, for the coating of surfaces, for example of wood, plastics, fibres or glass. The surface or the material lying under the coating can thus be protected, for example, against UV radiation.

The following examples serve to illustrate the invention without limiting it. The invention can be carried out correspondingly throughout the range indicated in this description.

### EXAMPLES

### Example 1

### Preparation of the Random Copolymer

254 g of lauryl methacrylate (LMA), 130 g of hydroxyethyl methacrylate (HEMA), 1 g of azoisobutyronitrile (AIBN) and 10 ml of mercaptoethanol are dissolved in 350 ml of toluene. The mixture is degassed and warmed at 70° C. for 24 h with stirring. 200 mg of AIBN are then added, and the mixture is stirred at 70° C. for a further 18 h.

For work-up, all volatile constituents are removed in vacuo, giving a random copolymer of LMA and HEMA in the ratio 1:1 having a number average molecular weight of about 2500 g/mol.

### Example 2

### Production of Stabilised ZnO Particles

150 ml of an ethanolic KOH solution (0.123 mol/l) are added to 75 ml of an ethanolic Zn(AcO)₂*2H₂O solution (0.123 mol/l) at 50° C.

The conversion into zinc oxide and the growth of the nanoparticles can be monitored by UV spectroscopy. After a reaction duration of only one minute, the absorption maximum remains constant, i.e. the ZnO formation is already complete in the first minute. The absorption edge shifts to longer wavelengths with increasing reaction duration. This can be correlated with continuing growth of the ZnO particles due to Ostwald ripening.

When the absorption edge reaches the value 360 nm, 20 ml of a solution of the random copolymer (weight concentration 100 g/l) from Example 1 are added. After the addition, no further shift in the absorption edge is observed. The suspension remains stable and transparent over a number of days.

A comparative experiment without addition of the polymer solution exhibits continued particle growth and becomes cloudy on continued observation.

For work-up, the ethanol is removed in vacuo, and the cloudy residue remaining is dissolved in 10 ml of toluene. The potassium acetate formed during the reaction can be separated off as a precipitate. The supernatant, clear solution furthermore exhibits the characteristic absorption of zinc oxide in the UV spectrum.

UV spectroscopy and X-ray diffraction demonstrate the formation of ZnO. Furthermore, no sodium acetate reflections are visible in the X-ray diagram.

A dispersion of polymer-modified zinc oxide which is redispersed in toluene to give a transparent dispersion is obtained.

### Example 3

### Surface-Coating Composition

A dispersion of the particles from Example 2 in PMMA coating material is prepared by mixing, applied to glass substrates and dried. The ZnO content after drying is 10% by weight. The films exhibit high transparency. Measurements using a UV/VIS spectrometer (Varian Carry 50) confirm this impression. The sample exhibits the following absorption values, depending on the layer thickness (the percentage of incident light which is lost in transmission is indicated).

| Layer thickness | UV-A (340 nm) | VIS (450 nm) |
|---|---|---|
| 2 μm | 90% | 5% |

Comparison:
(ZnO (extra pure, Merck) in PMMA coating material as above)

| | | |
|---|---|---|
| 2 μm | 64% | 46% |

1. Zinc oxide nanoparticles having an average particle size, determined by particle correlation spectroscopy (PCS), in the range from 3 to 20 nm whose particle surface has been modified by means of at least one copolymer comprising at least one monomer containing hydrophobic radicals and at least one monomer containing hydrophilic radicals, dispersed in an organic solvent, characterised in that they are obtainable by a process in which in a step a) one or more precursors of the nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the absorption edge in the UV/VIS spectrum of the reaction solution has reached the desired value, and optionally in step c) the alcohol from step a) is removed and replaced by another organic solvent.

2. Nanoparticles according to claim 1, characterised in that the zinc oxide particles have an average particle size, determined by particle correlation spectroscopy (PCS), of 5 to 15 nm, preferably 7 to 12 nm.

3. Nanoparticles according to claim 1, characterised in that the particle surface has been modified by means of a copolymer of the formula I 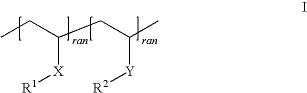
where X and Y correspond to the radicals of conventional nonionic or ionic monomers, and
R¹ stands for hydrogen or a hydrophobic side group, preferably selected from branched or unbranched alkyl radicals having at least 4 carbon atoms, in which one or more, preferably all, H atoms may be replaced by fluorine atoms, and
R² stands for a hydrophilic side group, which preferably contains one or more phosphonate, phosphate, phosphonium, sulfonate, sulfonium, (quaternary) amine, polyol or polyether radicals, particularly preferably one or more hydroxyl radicals,
ran means that the respective groups are arranged in a random distribution in the polymer, and where —X—R¹ and —Y—R² within a molecule may each have a plurality of different meanings, and the copolymers, besides the structural units shown in formula I, may contain further structural units, preferably those without or with short side chains, such as, for example, C₁₋₄-alkyl.

4. Nanoparticles according to claim 3, characterised in that X and Y, independently of one another, stand for —O—, —C(═O)—O—, —C(═O)—NH—, —(CH₂)ₙ—, phenylene or pyridyl, and at least one structural unit of the copolymer contains at least one quaternary nitrogen or phosphorus atom, where R² preferably stands for a —(CH₂)ₘ—(N⁺(CH₃)₂)—(CH₂)ₙ—SO₃⁻ side group or a —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ side group or a —(CH₂)ₘ—(P⁺(CH₃)₂)—(CH₂)ₙ—SO₃⁻ side group, where m stands for an integer from the range 1 to 30, preferably from the range 1 to 6, particularly preferably 2, and n stands for an integer from the range 1 to 30, preferably from the range 1 to 8, particularly preferably 3.

5. Nanoparticles according to claim 3, characterised in that the copolymer employed is a random copolymer, preferably essentially consisting of lauryl methacrylate (LMA) and hydroxyethyl methacrylate (HEMA).

6. Nanoparticles according to claim 3, characterised in that at least one structural unit of the copolymer is an oligomer or polymer, preferably a macromonomer, where polyethers, polyolefins and polyacrylates are particularly preferred as macromonomers.

7. Nanoparticles according to claim 3, characterised in that at least one structural unit of the copolymer contains a phosphonium or sulfonium radical.

8. Nanoparticles according to claim 3, characterised in that, besides the at least one structural unit containing hydrophobic radicals and the at least one structural unit containing hydrophilic radicals, the copolymers contain further structural units, preferably those without hydrophilic or hydrophobic side chains or with short side chains, such as C₁₋₄-alkyl.

9. Dispersion comprising nanoparticles according to claim 1 and a polymer.

10. Dispersion according to claim 9, characterised in that the dispersion is a surface coating or a surface-coating composition.

11. Process for the production of modified zinc oxide nanoparticles having an average particle size in the range from 3 to 20 nm, dispersed in an organic solvent, according to claim 1, characterised in that in a step a) one or more precursors of the nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the absorption edge in the UV/VIS spectrum of the reaction solution has reached the desired value, and optionally in step c) the alcohol from step a) is removed and replaced by another organic solvent.

12. Process according to claim 11, characterised in that the precursors are selected from the zinc salts of carboxylic acids or halides, preferably from zinc formate, zinc acetate, zinc propionate and zinc chloride, where zinc acetate is particularly preferred.

13. Process according to claim 11, characterised in that the conversion of the precursors is carried out by addition of base.

14. Process according to claim 11, characterised in that the absorption edge lies in the range 300-400 nm, preferably in the range up to 330-380 nm and particularly preferably in the range 355 to 365 nm.

15. Process according to claim 11, characterised in that the organic solvent is selected from alcohols, ethers, esters and hydrocarbons.

16. Process according to claim 11, characterised in that an emulsifier, preferably a nonionic surfactant, is employed.

17. Zinc oxide nanoparticles having an average particle size, determined by particle correlation spectroscopy (PCS), in the range from 3 to 50 nm, characterised in that they are obtainable by a process according to claim 11, but where, in step c), the alcohol from step a) is removed to dryness.

18. Process for the production of zinc oxide nanoparticles having an average particle size, determined by particle correlation spectroscopy (PCS), in the range from 3 to 50 nm, characterised in that they are obtainable by a process according to claim 11, but where, in step c), the alcohol from step a) is removed to dryness, characterised in that they are produced by a process according to claim 11, but where, in step c), the alcohol from step a) is removed to dryness.

19. A method for the UV stabilisation of polymers comprising using nanoparticles of claim 1.

20. Polymer composition essentially consisting of at least one polymer, characterised in that the polymer comprises nanoparticles according to claim 17.

21. Polymer composition according to claim 20, characterised in that the polymer is polycarbonate, polyethylene terephthalate, polyimide, polystyrene, polymethyl methacrylate or a copolymer comprising at least a proportion of one of the said polymers.

22. Process for the preparation of polymer compositions, characterised in that the polymer material is mixed with nanoparticles according to claim 17, preferably in an extruder or a compounder.

23. Wood treated with a dispersion according to claim 9.

24. Plastic treated with a dispersion according to claim 9.

25. Fibre treated with a dispersion according to claim 9.

26. Glass treated with a dispersion according to claim 9.

27. Plastic comprising a polymer composition according to claim 17.

28. Fibre comprising a polymer composition according to claims 17.
